(19) United States
(12) Patent Application Publication
(10) Pub. No.: US 2025/0335039 A1
(43) Pub. Date: Oct. 30, 2025

(54) VIRTUAL INPUT DEVICE

(71) Applicant: OXTI Pte Ltd, Singapore (SG)

(72) Inventor: Chih-Feng Ho, Singapore (SG)

(21) Appl. No.: 18/644,138

(22) Filed: Apr. 24, 2024

(51) Int. Cl. G06F 3/01; G02B 27/01

(52) U.S. Cl. CPC G06F 3/017; G02B 27/017; G06F 3/011

(57) ABSTRACT

A virtual input device includes a head-mounted display device including an image projection module and a control module; a hand gesture detection module arranged on the head-mounted display device and electrically connected with the control module; and a transmission module electrically connected with the control module. The image projection module to project and form a virtual device. The hand gesture detection module detects a hand gesture of a user to serve as a hand gesture input. The control module outputs a drive signal in response to the hand gesture input. The transmission module transmits the drive signal to a physical device that is externally located. To operate the physical device, such as a mobile phone or computer, the user may use the head-mounted display device to project and form a virtual mobile phone or computer on a desk top to ease the operation of the physical device.

### BACKGROUND OF THE INVENTION

### (a) Technical Field of the Invention

The present invention relates to an input device, and more particularly to a virtual input device.

### (b) Description of the Prior Art

The development of electronic communication devices is in the trend of size miniaturization. For the purposes of maneuverability of the portable electronic devices, namely fulfilling the ultimate goal of enabling communication with anyone at any time and any place, the size of the electronic devices cannot be unlimitedly expanded, and consequently, the existing portable electronic devices suffer small screen size.

To overcome such a problem, Taiwan Patent 1307032 provides a keyboard input method and device, which suggests a direction control button be combined with an existing button or shown on a screen as a virtual button, in order to suit the need for input with an existing interface to drive a corresponding button to allow a user to make inputs.

Although the know technology described above allows a screen display area to be expanded, yet in case that for a display screen of a portable electronic device is relatively small, while the screen is displaying an image, there is a simultaneous need for operating a virtual button on the screen for carrying out inputting, the inputting operation cannot be properly performed for directly entering characters, texts, or controls before the image that is being displayed is reduced in size to allow the virtual button to display on the screen for operation for inputting. The operation is inconvenient and further improvement is necessary.

### SUMMARY OF THE INVENTION

To achieve the above-mentioned objective, the present invention provides a virtual input device, which comprises: a head-mounted display device, which comprise an image projection module and a control module; a hand gesture detection module, which is arranged on the head-mounted display device, the hand gesture detection module being electrically connected with the control module; and a transmission module, which is electrically connected with the control module.

The head-mounted display device can be a head-mounted augmented reality (AR) display device or a head-mounted virtual reality (VR) display device.

The hand gesture detection module can be a non-contact hand gesture detection module, comprising an ultrasonic, laser, or infrared based hand gesture detection module.

The transmission module can be an infrared, ZigBee, Bluetooth, radio frequency, or laser based wireless transmission module.

The transmission module can be a serial bus, RS232, or IEEE1394 based wired transmission module.

The head-mounted display device uses the image projection module to project and form a virtual device, and uses the hand gesture detection module to detect a hand gesture of a user to serve as a hand gesture input, and uses the control module to output a drive signal according to a requirement of the user to which the hand gesture input corresponds, and uses the transmission module to transmit the drive signal to a physical device that is externally located. For example, if the user attempts to operate a mobile phone or computer, but considers the mobile phone screen or the computer screen is relatively small and is not easy to use, the user may use the present invention to project and form a virtual mobile phone or computer at any time on a desk top, making the use extremely convenient.

### BRIEF DESCRIPTION OF THE DRAWINGS

FIG. 1 is a schematic view showing a virtual input device according to the present invention.

FIG. 2 is a block diagram of the virtual input device according to the present invention.

FIG. 3 is a schematic view showing use of the virtual input device according to the present invention.

FIG. 4 is a schematic view showing the virtual input device according to the present invention projecting a virtual device.

### DETAILED DESCRIPTION OF THE PREFERRED EMBODIMENTS

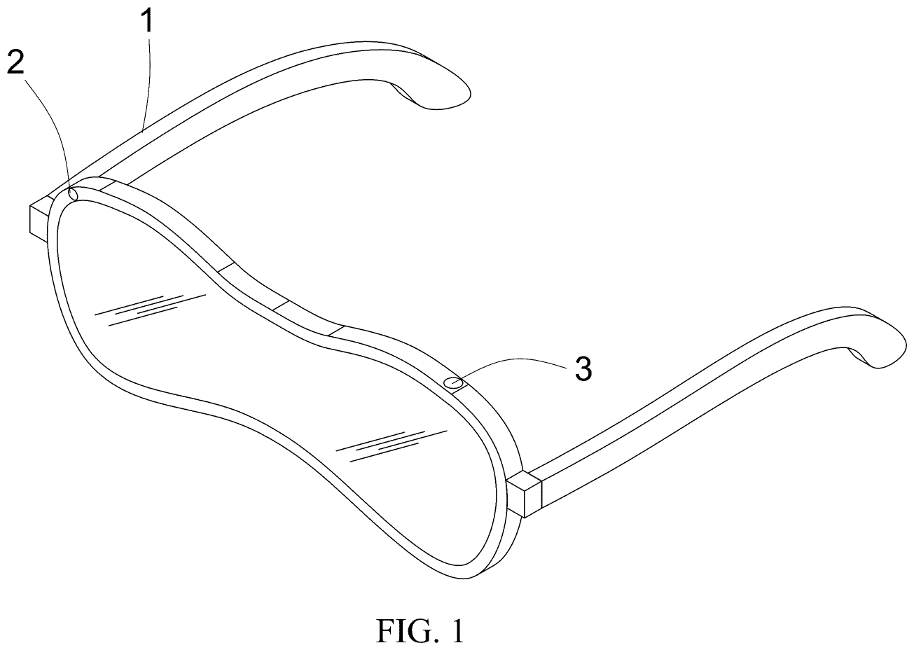

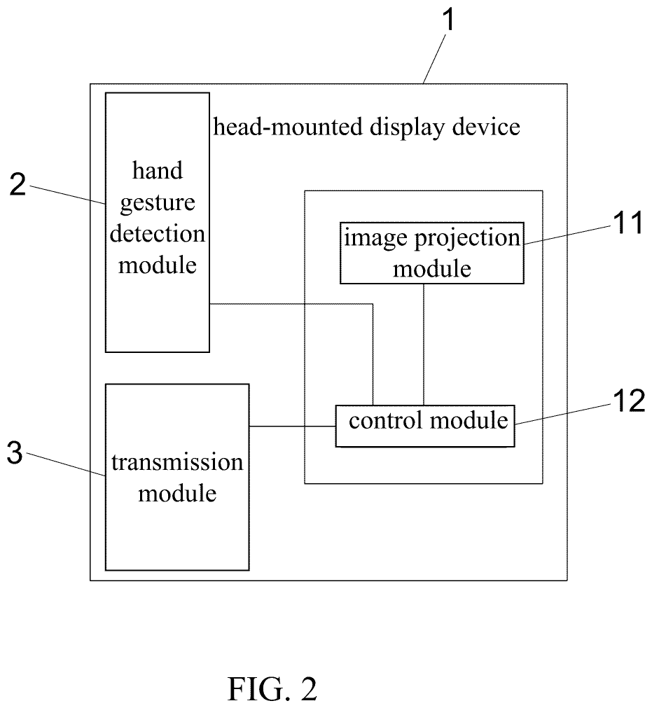

Referring to FIGS. 1 and 2, the present invention provides a virtual input device, which comprises: a head-mounted display device 1, a hand gesture detection module 2, and a transmission module 3.

The head-mounted display device 1 comprises an image projection module 11 and a control module 12. The head-mounted display device 1 can be a head-mounted augmented reality (AR) display device or a head-mounted virtual reality (VR) display device. The image projection module 11 functions to project a virtual image. Taking an AR display device as an example, the image projection module 11 functions as an optical machine of AR display device. The term “|optical machine” is a simplified term for “optoelectrical precision instrument and machines”. The optical machine comprises a light source, an optical waveguide, and an optical grating. In the AR display device, the optical machine often includes a miniature light-emitting diode (LED) or a laser source to generate image data, and the optical waveguide technology is applied to transmit, by means of refraction and total reflection, the image data to a retina of a user to allow the user to see the virtual image, while not affecting the user's observation of a physical site view. The control module 12 includes functions of logic operations, storage of operation results, and execution of instructions, and the control module 12 can be a central processing unit (CPU), a microprocessor unit (MPU), a microcontroller unit (MCU), or an application specific integrated circuit.

The hand gesture detection module 2 is arranged on the head-mounted display device 1, and the hand gesture detection module 2 is electrically connected with the control module 12. The hand gesture detection module 2 is a non-contact hand gesture detection module, including ultrasonic, laser, or infrared based hand gesture detection modules. As an example of illustration, an infrared based hand gesture detection module comprises an infrared LED, a sensor, and a microcontroller. When the sensor detects an object, the infrared LED emits infrared light and receives energy reflected by an object upon which the infrared light impinges to convert into an electronic signal, with which a user's hand gesture, including moving path and location of the hand, is detected to serve as a hand gesture input. The sensor transmits data of the hand gesture to the microcontroller, and the microcontroller is loaded with software that analyzes and determines the user's hand gesture, such a hand waving direction. For example, the microcontroller may be loaded with a preset hand gesture, and the microcontroller execute software to identify, through comparison, if the hand gesture input corresponds to or matches the preset hand gesture in order to generate a hand gesture comparison signal according to the result of comparison. Afterwards, the hand gesture detection module 2 transmits the hand gesture comparison signal to the control module 12, and the control module 12 outputs a drive signal according to a user's requirement corresponding to the hand gesture input. The corresponding relationship between the hand gesture input and the user's requirement can be pre-stored in the control module 12, and the control module 12 outputs the drive signal according to the corresponding relationship between the hand gesture input and the user's requirement.

The transmission module 3 is electrically connected with the control module 12. The transmission module 3 can be an infrared, ZigBee, Bluetooth, radio frequency, or laser based wireless transmission module. Or alternatively, the transmission module 3 can be a serial bus, RS232, or IEEE1394 based wired transmission module.

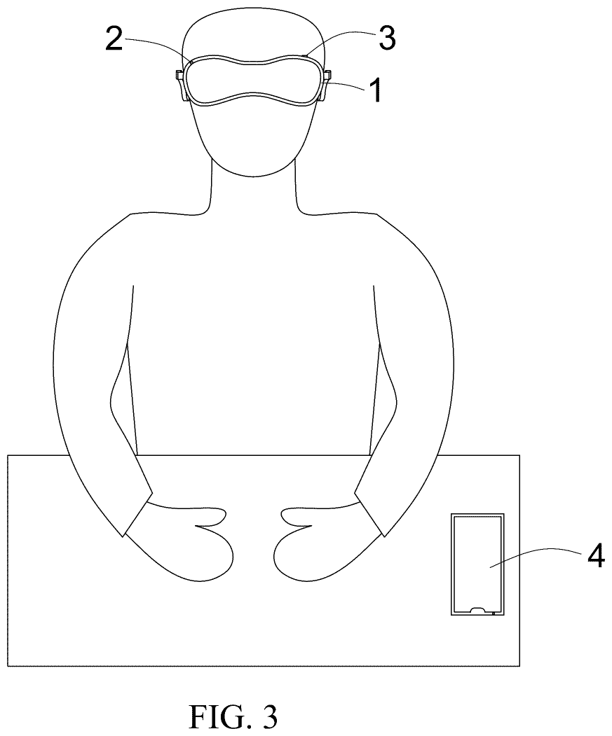

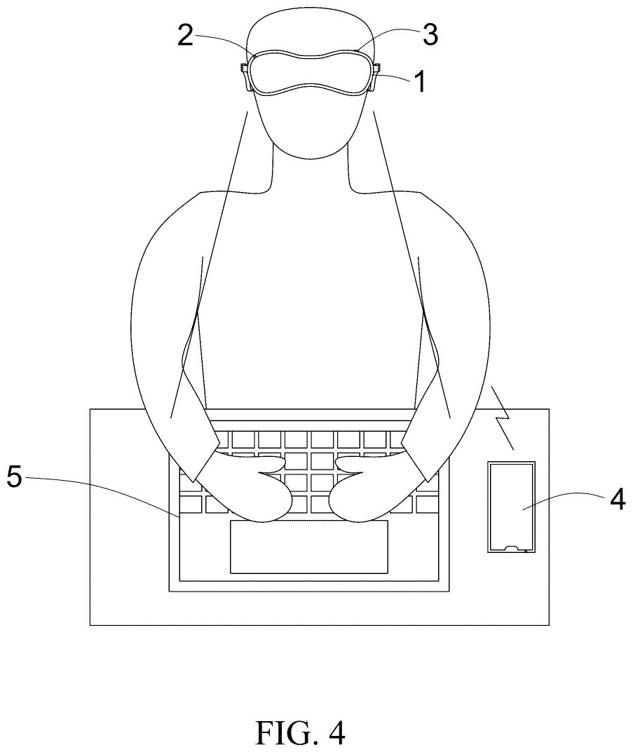

Referring to FIGS. 3 and 4, use of the virtual input device according to the present invention can be implemented with the following steps:
Step (a), a user wearing the head-mounted display device 1, where a physical device 4 is arranged at a proximal site or a distant site, wherein the physical device 4 can be an actual mobile phone or computer; Step (b), the head-mounted display device 1 using the image projection module 11 to project a virtual device 5, wherein the virtual device 5 can be a virtual mobile phone or computer, and the user may user a hand gesture to operate the virtual device 5; Step (c), the head-mounted display device 1 using the hand gesture detection module 2 to detect the hand gesture of the user to serve as a hand gesture input; Step (d), the head-mounted display device 1 using the control module 12 to output a drive signal according to a requirement of the user to which the hand gesture input corresponds, such as pressing down a button of the mobile phone or computer; and Step (e), the head-mounted display device 1 using the transmission module 3 to transmit the drive signal, in a wireless manner or a wired manner, to the physical device 4.

As such, the head-mounted display device 1 uses the image projection module 11 to project and form a virtual device, and uses the hand gesture detection module 2 to detect a hand gesture of a user to serve as a hand gesture input, and uses the control module 12 to output a drive signal according to the requirement of the user to which the hand gesture input corresponds, and uses the transmission module 3 to transmit the drive signal to a physical device 4 that is externally located. For example, if the user attempts to operate a mobile phone or computer, but considers the mobile phone screen or the computer screen is relatively small and is not easy to use, the user may use the present invention to project and form a virtual mobile phone or computer at any time on a desk top, making the use extremely convenient. Compared with the prior art, the present invention makes a direct projection of a virtual device 5, rather than just displaying of a virtual button on a screen, so that the operation is made convenient.

I claim:

1. A virtual input device, comprising:
a head-mounted display device, which comprises an image projection module and a control module;
a hand gesture detection module, which is arranged on the head-mounted display device, the hand gesture detection module being electrically connected with the control module; and
a transmission module, which is electrically connected with the control module.

2. The virtual input device according to claim 1, wherein the head-mounted display device is a head-mounted augmented reality (AR) display device or a head-mounted virtual reality (VR) display device.

3. The virtual input device according to claim 1, wherein the hand gesture detection module is a non-contact hand gesture detection module, comprising an ultrasonic, laser, or infrared based hand gesture detection module.

4. The virtual input device according to claim 1, wherein the transmission module is an infrared, ZigBee, Bluetooth, radio frequency, or laser based wireless transmission module.

5. The virtual input device according to claim 1, wherein the transmission module is a serial bus, RS232, or IEEE1394 based wired transmission module.
